(19) United States
(12) Patent Application Publication
(10) Pub. No.: US 2010/0057625 A1
(43) Pub. Date: Mar. 4, 2010

(54) NEGOTIATION OF POWER RATES BASED ON DYNAMIC WORKLOAD DISTRIBUTION

(75) Inventors: Gregory J. Boss, American Fork, UT (US); James R. Doran, New Milford, CT (US); Rick A. Hamilton, II, Charlottesville, VA (US); Anne R. Sand, Peyton, CO (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/203,366

(22) Filed: Sep. 3, 2008

(51) Int. Cl. G06Q 30/00; G06Q 10/00; G06Q 50/00

(52) U.S. Cl. 705/80; 705/7

(57) ABSTRACT

A consumer initiated automated and dynamic negotiation enables the consumer to obtain more beneficial rates and/or other terms between the consumer and one or more energy providers. The negotiation is based on anticipated computational processing requirements of the consumer, and the current energy costs being offered by each provider. Other elements such as the ability of the provider to timely supply the energy and the differential between the costs of traditional and green energy may also be factored in. The results of the negotiation can produce a shifting of all or part of the workload to another provider or an alternative geographical location to capitalize on lower power rates or conditions of delivery. The negotiation may be based on an auction between more than one competing energy supplier.

### FIELD OF THE INVENTION

The invention relates to computer technology associated with the financial aspects of data processing, particularly as it deals with the economic and practical analysis for selecting energy providers based on multiple energy criteria.

### BACKGROUND OF THE INVENTION

Currently, computing workloads are processed within relatively static data centers. Disaster recovery mechanisms exist to transfer data or processing to an alternate site based on an outage at the original location. Meanwhile, IT power costs have been increasing, causing some experts to predict that power costs will soon overtake computer hardware costs.

Grid computing enables the distribution of compute workloads based on available resources. It does not include methods for determination of a processing location based on real-time energy costs. The nature of computational workloads is unique in that they are more easily relocated than other power needs. A company cannot decide to shut down its downtown Chicago headquarter offices and shift that function to western New York, only to move it back the following week. Similarly, a consumer cannot decide to relocate its residence from Virginia to North Carolina based on power prices, only to return a day later. Such decisions can be more reliably made, of course, over the long term, but the geographically-independent nature of compute jobs provides a unique mobility.

Power and air conditioning costs are a significant burden for corporate IT budgets. The cumulative energy cost for servers and data centers in the U.S. in the year 2006 was approximately $3.3 billion annually. The overall electricity used by IT servers doubled between 2000 and 2005, and is expected to continue to grow. Customers are seeking ways to improve their profitability by reducing their power costs. In today's environment computing jobs are assigned to data centers based on the availability of computing resources. There are no existing methods to assign computing jobs based on energy resource metrics. Two separate target locations in consideration for a computing job assignment by a dispatcher could both be capable of completing the job but there may be varying costs associated with power consumption at those diverse locations.

Jobs can be dispatched based on real-time energy costs. However, it would be advantageous for both the energy provider and the consumer to have a system that enables a renegotiation of power costs based on an intent to redistribute workload. This could lower costs for the consumer, retain customers for the energy provider and reduce the amount of time and cost associated with transferring a workload to another location.

### BRIEF DESCRIPTION OF THE INVENTION

This invention relates to methods and systems for customer-initiated automated and dynamic negotiation of power rates based on compute workload balancing. It enables customers to negotiate directly with power providers or through an auction. For purposes of the present invention, power is defined as the electrical energy resource used by businesses and individual consumers. The power rate is the amount charged by the power provider per unit of time or other quantitatively measurable elemental unit of use.

This invention also relates to the automated negotiation of power rates between consumer and provider, based on computational processing requirements and current energy provider costs, given that a certain percentage (either totally or partially known) of the workload may be shifted to another provider. Such shifting of workloads may entail geographic redistribution of the workload to take advantage of preferred power rates or conditions in other geographies or it may be a geographically-stationary scenario wherein a different power service provider is tapped for providing the service.

In either case, a customer or workload dispatcher may inform a utility that it is about to redirect X load for processing compute jobs to another location at Y price. This enables the utility to lower its price in order to keep the cost equivalent, or close enough to retain the business. A successful renegotiation will result in a cost falling below a threshold and the canceling of the workload redistribution decision.

Additionally, the customer may place “energy blocks” out for bid to multiple energy providers, in order to obtain the lowest energy costs. An energy block is a unit of power that a consumer is willing to commit to spend and consume, typically within a given time frame. The consumer chooses how to consume that energy but typically the larger the energy block(s) the more of a discount a provider will be willing to give.

The consumer may also consider the relative price differential of green energy versus conventional energy, taking into account the triple bottom line of economic viability, social responsibility, and environmental impact. The term ‘green energy’ has been described as a source of energy which is considered to be environmentally friendly and non-polluting. Such a source may be solar, wind, biomass, or hydro energy.

In another embodiment, the invention also involves a method and a system for a power consumer to initiate and negotiate a price with an energy provider for the consumer's future compute workload requirements. This involves the steps of estimating its future compute workload power requirements. Current rates are obtained from eligible providers. The overall cost of transferring from one provider to another is calculated. Armed with this information, a target price for the workload requirement is then determined. With this information, the consumer can determine the amount of the workload to redistribute based upon the consumer's requirements, current rates of eligible providers, and redistribution costs. The current energy provider may optionally be given an opportunity to adjust its energy costs to the consumer in response to the target price determined by the consumer. The consumer can conclude by awarding a contract for future energy requirements to a low bidder. Alternatively, the consumer can initiate an auction between two or more energy suppliers to meet the energy requirements of the consumer based upon the target price.

In addition, the invention also utilizes a computer-readable medium and a program product containing the necessary instruction for the consumer to negotiate with an energy supplier based upon these steps. Alternatively, the negotiation can be carried out by a service provider using these same criteria.

### BRIEF DESCRIPTION OF THE DRAWINGS

These and other features of this invention will be more readily understood from the following detailed description of the various aspects of the invention taken in conjunction with the accompanying drawing in which:

FIG. 1 represents a workload dispatcher hub;

FIG. 2 is a representative flow diagram of a targeted negotiation;

FIG. 3 shows a flow diagram of a general negotiation; and

FIG. 4 is a block diagram illustrating an exemplary computerized system and method for implementing the present invention.

The drawings are not intended to be drawn to scale. Instead, the drawings are merely a schematic representation, not intended to portray specific parameters of the invention. The drawings are intended to depict only typical embodiments of the invention, and therefore should not be considered as limiting the scope of the invention.

### DETAILED DESCRIPTION OF THE INVENTION

According to one embodiment of the invention, two main methods are disclosed for price negotiation for power. The first is negotiation between one consumer and one provider, and the second is an auction scenario, wherein one consumer communicates with several potential energy providers.

This invention may utilize the framework described in co-pending patent Docket END920070333US 1 entitled FRAMEWORK FOR DISTRIBUTION OF COMPUTER WORKLOADS BASED ON REAL TIME ENERGY COSTS and the methods describe in END920070334US 1 entitled ANALYSIS OF ENERGY-RELATED FACTORS FOR SELECTING COMPUTATIONAL JOB LOCATIONS. Optionally, this invention may utilize other frameworks and distribution methods for negotiation of power rates.

Compute workload jobs possess a unique characteristic over manual work in that such jobs are easily relocated to other locations. Grid computing is well known and demonstrates that compute workloads are mobile and may be run independent of a particular location.

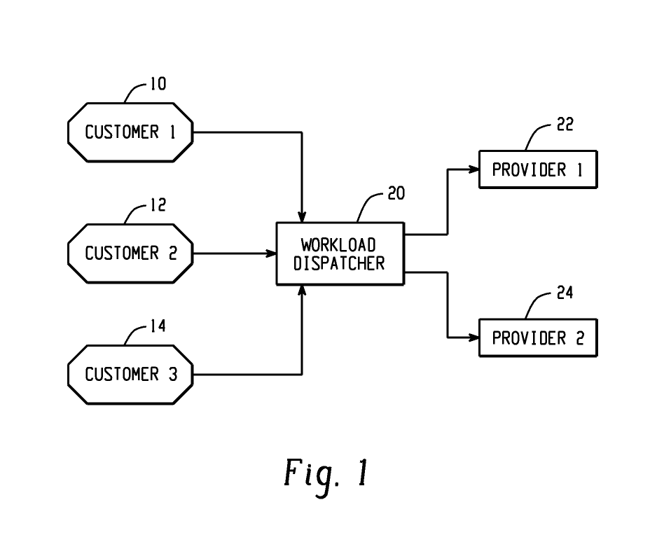

Negotiation among customers and energy providers may occur directly or through a third party. FIG. 1 shows a Workload Dispatcher hub that may act as an intermediary or service provider among customers and providers. As shown therein, three different customers 10, 12 and 14 provide input to a workload dispatcher 20. The dispatcher is shown conducting negotiation with two separate energy suppliers or providers 22 and 24.

Negotiation directly between the consumer and a provider utilizes the combined usage of the following steps for the negotiation:

First, collection of competitive data by a workload dispatcher; Then, automated negotiation between customer and provider based on predefined metrics; and

Finally, reach a conclusion with either a decision to stay with existing provider, or shift providers based on these negotiations.

On the other hand, auto negotiation directly between the customer and multiple power providers utilizes the combined usage of the following procedure for negotiation:

Collection of competitive data by a workload dispatcher;

Automated negotiation between customer and multiple providers, using auction scenario; and

Conclude with either a decision to stay or shift providers based on these negotiations.

In more detail, a targeted price negotiation wherein the customer negotiates individually with the provider involves the following steps:
1. The customer system determines compute workload power requirements and criteria such as, but not limited to a) when needed, b) how much, c) what locations, d) is a renewable source mandatory;
2. The customer system queries workload dispatcher hub 20 to obtain current rates for eligible providers;
3. The customer system prefers to run job at Location A, but sees that Provider A has higher rates than Provider B;
4. The customer calculates the cost to move the job (time, human resource, power resource, quality of service);
5. The customer system notifies Provider A (via the Workload Dispatcher 20) that the customer will move the compute job to Location B unless target rate is met;
6. Provider A has an option to lower the rate to match competitor's cost;
7. Provider A system may examine its available power at that time and meet the lower price if desired;
8. The customer accepts Provider A's lower price (via the Workload Dispatcher hub 20) and runs compute job at Location A.

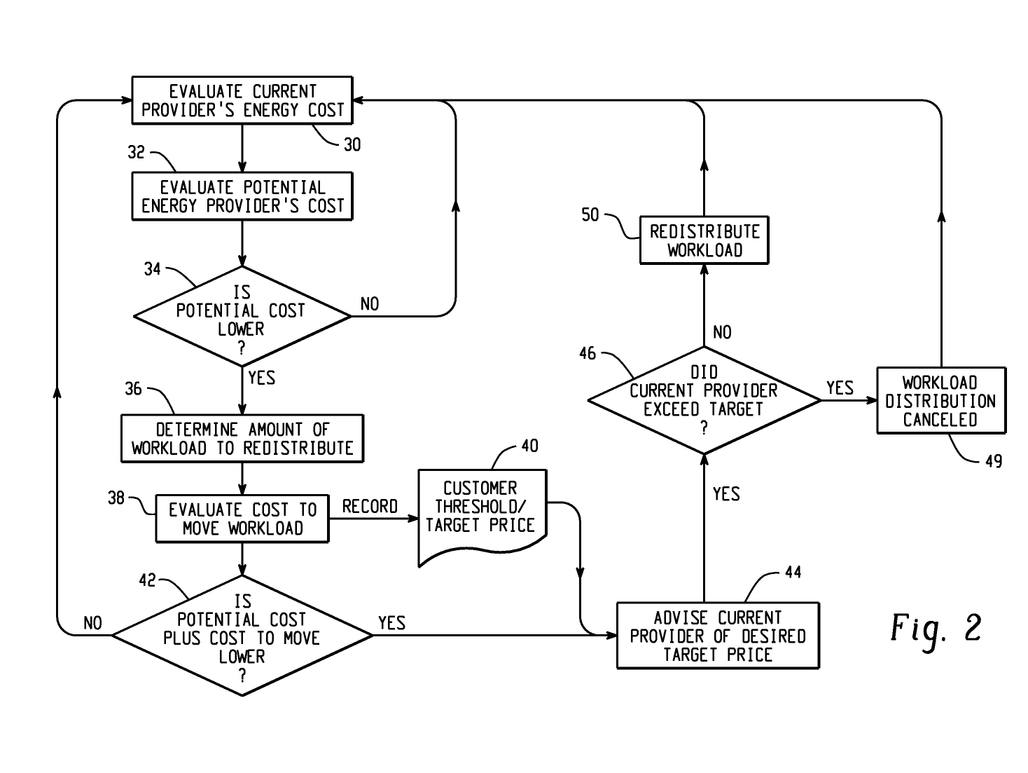

FIG. 2 shows the flow of logic that occurs during targeted negotiation. The current energy costs are evaluated at step 1, (30) and then are compared in step 2, (32) with the energy cost of a potential provider. If the potential cost is determined in step 3 at 34 not to be lower, the negotiation returns to step 1. If, on the other hand, the potential costs are determined to be lower, step 3 involves a determination at 36 of the amount of workload to parse out to a potential energy provider. The moving costs are then determined at 38 and are recorded at 40. If the potential savings are determined at 42 to be higher, then the cycle is restarted at 30. If, however, the potential energy cost savings are determined at 42 to be greater than the moving cost, the current provider is then advised at 44 of a desired target price. The current provider then determines at 46 if it will meet the price. At this point, if the current energy provider agrees to drop its price to meet the target, the workload distribution plan is canceled at 49. If not, redistribution of the workload occurs at 50. In any event the new energy cost is then sent to the evaluator at 30.

In another embodiment, auto negotiation using an auction will utilize the following for pricing of power through an auction:

Calculating power usage needs;

Posting power needs to a “publicly available” workload dispatcher;

Collecting bids from power providers;

Concluding with a decision to stay with the present provider or shift providers based on these bids.

A power price auction scenario in which the customer puts the job out to bid involves the following:
1. The customer determines compute workload power requirements and criteria (when needed, how much, locations, if renewable source is mandatory, etcetera)
2. The customer posts job to the Workload Dispatcher hub
3. Eligible providers are notified of request
4. Providers have the opportunity to bid for the job (system may automatically bid, or human intervention may be used)
5. The customer evaluates compute location options and costs per location
6. Provider may or may not be shown the prices offered by other providers
7. The customer may submit counter offers
8. Providers may respond to counter offers, either automatically via system or with human intervention
9. Lowest total cost utility meeting criteria wins the bid
10. The provider is automatically selected and the compute job is automatically transferred to winning provider.

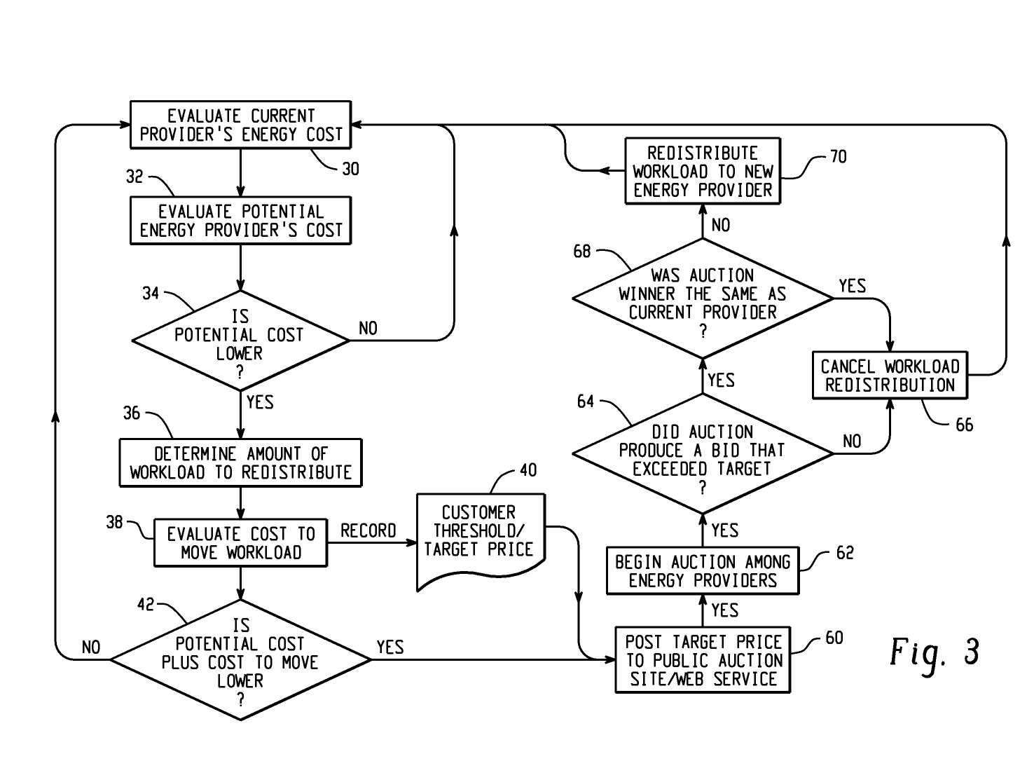

FIG. 3 shows the flow of logic that occurs during these general negotiations. The current energy costs are evaluated at step 1, (30) and then are compared in step 2, (32) with the energy cost of a potential provider. If the potential cost is determined in step 3 at 34 not to be lower, the negotiation returns to step 1. If, on the other hand, the potential costs are determined to be lower, step 3 involves a determination at 36 of the amount of workload to parse out to a potential energy provider. The moving costs are then determined at 38 and recorded at 40. If the potential savings is determined at 42 to be higher, then the cycle is restarted at 30. Up to this point, the steps are seen to duplicate those shown in FIG. 2 for targeted negotiation. If, however, the potential energy cost savings is determined at 42 to be greater than the moving cost, the target price is posted on a public site at 60. An auction then begins at 62. If the bid fell short, then the workload redistribution is canceled at 66, and the evaluation procedure is restarted at 30. On the other hand, if it is determined at 64 that the auction successfully produced a satisfactory bid, then a determination is made at 68 whether the bid was submitted by the current supplier. If so, the workload redistribution is canceled at 66. If, however, the winning bid was not submitted by the current supplier, then redistribution occurs at 70.

In another aspect of the present invention, energy providers can utilize creative pricing schemes, such as the following to entice users and maximize their profits.
Providers may use many different criteria to determine the price that they will offer. Factors may be customer importance, including membership in a loyalty program, amount of revenue generated by customer, QoS (Quality of Service) contracts, availability of excess power, etc.
Prices for processing a particular workload may vary based on other attributes of the power, including the originating geography, the provider, or the use of power from a renewable source. Customers may negotiate their choices based on any of the attributes of the power.
Provider and customer may negotiate pricing of power for workload based on day/time it is run, or offer discounts for flexible timing options.

When a customer can be flexible with the date and time a job can be run, opportunities are available for negotiating discounted rates. These negotiations may occur either directly between consumer and provider, or on an auction system described above. Scientific compute jobs run by university students are an example of a type of job that would consume large compute resources (which require power to run and cool). Since these are research tasks, they may be more flexible on timing than real-time business transactions. In this iteration of the invention, the customer registers compute work job, indicating flexible timing for when it is run (e.g. any time in next 3 days). The provider and customer negotiate and agree to discounted pricing for customer's timing flexibility. The job is then put into wait state. When the provider has excess capacity, the customer is automatically notified, and the job is automatically initiated or the customer then gives the authorization to proceed.

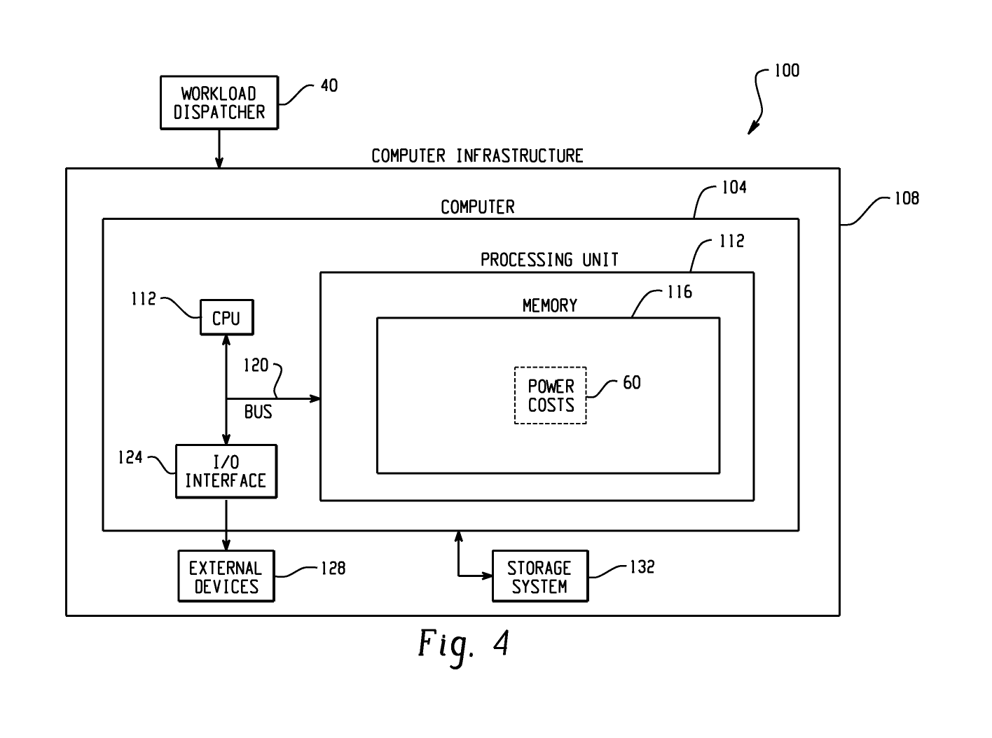

Referring now to FIG. 4, an exemplary computerized implementation of the present invention includes a computer system 100 having a computer 104 deployed within a computer infrastructure 108 such as that existing with user interface described above. This is intended to demonstrate, among other things, that the present invention could be implemented within a network environment (e.g., the Internet, a wide area network (WAN), a local area network (LAN), a virtual private network (VPN), etc.), or on a stand-alone computer system.

In the case of the former, communication throughout the network can occur via any combination of various types of communications links. For example, the communication links can comprise addressable connections that may utilize any combination of wired and/or wireless transmission methods.

Where communications occur via the Internet, connectivity could be provided by conventional TCP/IP sockets-based protocol, and an Internet service provider could be used to establish connectivity to the Internet. Still yet, computer infrastructure 108 is intended to demonstrate that some or all of the components of the implementation could be deployed, managed, serviced, etc. by a service provider who offers to implement, deploy, and/or perform the functions of the present invention for others.

As shown, the computer system 100 includes a computer 104, a processing unit (CPU) 112, a memory 116, a bus 120, and input/output (I/O) interfaces 124. Further, the computer system 100 is shown in communication with external I/O devices/resources 128 and storage system 132. In general, the processing unit 112 executes computer program code, such as a code to implement the initiation and conducting of the negotiation of the present invention, which code is stored in memory 116 and/or storage system 132. It is to be appreciated that two or more, including all, of these components may be implemented as a single component.

While executing computer program code, the processing unit 112 (also shown as CPU 112) can read and/or write data to/from the memory 116, the storage system 132, and/or the I/O interfaces. The bus 120 provides a communication link between each of the components in computer 104. The external devices 128 can comprise any devices (e.g., keyboard, pointing device, display, etc.) that enable a user to interact with computer 104 and/or any devices (e.g., network card, modem, etc.) that enable computer system to communicate with one or more other computing devices.

The computer infrastructure 108 is only illustrative of various types of computer infrastructures for implementing the invention. For example, in one embodiment, computer infrastructure 108 comprises two or more computing devices (e.g., a server cluster) that communicate over a network to perform the various process steps of the invention. Moreover, computer 104 is only representative of various possible computers that can include numerous combinations of hardware.

To this extent, in other embodiments, the computer system 100 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit 112 may comprise a single processing unit, or be distributed across multiple processing units in one or more locations, e.g., on a client and server. Similarly, the memory 116 and/or the storage system 132 can comprise any combination of various types of data storage and/or transmission media that reside at one or more physical locations. Power costs 60, shown in outline in FIG. 4 are but a few of the items that can be stored in the memory 116 of the computer 104.

Further, I/O interface 124 can comprise any of the systems for exchanging information with one or more of the external devices 128. Still further, it is understood that one or more additional components (e.g., system software, math co-processing unit, etc.) not shown in FIG. 1 can be included in computer system 100. However, if the computer 104 comprises a handheld device or the like, it is understood that one or more of the external devices 128 (e.g., a display) and/or the storage system 132 could be contained within computer 104, not externally as shown.

The storage system 132 can be any type of system (e.g., a database) capable of providing storage for information under the present invention. To this extent, the storage system 132 could include one or more storage devices, such as a magnetic disk drive or an optical disk drive. In another embodiment, the storage system 132 includes data distributed across, for example, a local area network (LAN), wide area network (WAN) or a storage area network (SAN) (not shown). In addition, although not shown, additional components, such as cache memory, communication systems, system software, etc., may be incorporated into computer system 100.

While shown and described herein as a method and system for conducting negotiations between a customer and power providers, it is understood that the invention further provides various alternative embodiments. For example, in one embodiment, the invention provides a computer-readable/useable medium that includes computer program code to enable a computer infrastructure to manage negotiations. To this extent, the computer-readable/useable medium includes program code that implements each of the various process steps of the invention.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 116 (FIG. 4) and/or the storage system 132 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to manage the user's interface with the power providers. In this case, the service provider can perform the function of the workload dispatcher 40, and can create, maintain and support a computer infrastructure that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing the computer bidding system of the present invention. In this case, a computer infrastructure, such as computer infrastructure 108 (FIG. 4), can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 100 (FIG. 4), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for a power consumer to initiate and negotiate a price with an energy provider for the consumer's future compute workload requirements, comprising the steps of:
estimating the customer's future compute workload power requirements;
obtaining current power rates of eligible energy providers;
calculating cost of transferring from one energy provider to another;
determining a target price for the workload requirements; and
selecting an energy provider based upon its abilities to meet the target price.

2. The method according to claim 1 further including a step of determining the amount of the workload to redistribute based upon the consumer's requirements, current rates of eligible energy providers, and redistribution costs.

3. The method according to claim 2 further including the step of providing an opportunity for a current energy provider to adjust its energy costs to the consumer in response to the consumer's determined target price.

4. The method according to claim 1 further including the step, prior to selecting the energy provider, of initiating an auction between two more energy providers to meet the energy requirements of the consumer based upon the target price.

5. The method according to claim 1 further including the step of awarding a contract for future energy requirements to a low bidder.

6. A system for a power consumer to automatically negotiate a price with an energy provider for computer workload requirements comprising;
a calculation of the estimated future compute workload power requirements;
a schedule of current rates of eligible energy providers;
a calculation representing the cost of transferring from one energy provider to another; and
a target price based upon at least these three factors for the workload requirements.

7. The system according to claim 6 further including a step of determining the amount of the workload to redistribute based upon the consumer's requirements, current rates of eligible providers, and redistribution costs.

8. The system according to claim 7 further including the provision of an opportunity for a current energy provider to adjust its energy costs to the consumer.

9. The system according to claim 7 further including an auction between two more energy suppliers to meet the energy requirements of the consumer based upon the target price.

10. The system according to claim 6 further including a contract for awarding a customer's future energy requirements to a low bidder.

11. A computer-readable medium containing instructions, when implemented on a computer, for automatically negotiating with an energy supplier based upon a prospective power consumption of at least one computer processing system by a method comprising:
estimating the future compute workload power requirements of a consumer;
obtaining current rates of eligible energy providers;
calculating cost of transferring from one provider to another; and
determining a target price for the workload requirements.

12. The computer-readable medium containing instructions according to claim 11 further including a step of determining the amount of the workload to redistribute based upon the consumer's requirements, current rates of eligible energy providers, and redistribution costs.

13. The computer-readable medium containing instructions according to claim 12 further including the step of providing an opportunity for a current energy provider to adjust its energy costs to the consumer.

14. The computer-readable medium containing instructions according to claim 12 further including the step of initiating an auction between two more energy providers to meet the energy requirements of the consumer based upon the target price.

15. The computer-readable medium containing instructions according to claim 14 further including the step of awarding a contract for future energy requirements to a low bidder.

16. A program product including a medium on which a computer program is recorded, said computer program including:
a first set of instructions for obtaining competitive cost data from energy providers;
a second set of instructions for estimating future requirements for a consumer's compute workload;
a third set of instructions for collecting current rates available from eligible energy providers;
a fourth set of instructions for calculating cost of transferring from a current provider to another; and
program logic for initiating said sets of instructions to make a determination regarding an option to select an energy supplier to provide power for a consumer to perform the compute workload.

17. The program product according to claim 16 wherein the medium contains instructions for determining the amount of the workload to redistribute based upon the consumer's requirements, current rates of eligible energy providers, and redistribution costs.

18. The program product according to claim 16 wherein the medium contains instructions for giving an opportunity for a current energy provider to adjust its energy costs to the consumer.

19. The program product according to claim 16 wherein the medium contains instructions further including the step of initiating an auction between two or more energy suppliers to meet the energy requirements of the consumer based upon the target price.

20. The program product according to claim 19 wherein the medium contains instructions further including the step of awarding a contract for future energy requirements to a low bidder.

21. A method in a computer system for a service provider to negotiate optimum contract terms for a quantum of energy for a compute operation, said method comprising:
estimating computer workload power requirements of a consumer;
obtaining current rates of eligible energy providers,
calculating cost of transferring the workload from one energy provider to another; and
selecting the energy provider with the optimum contract terms.

22. The method in a computer system according to claim 21 further enabling the service provider to determine the amount of the workload to redistribute based upon the consumer's requirements, current rates of eligible providers, and redistribution costs.

23. The method in a computer system according to claim 22 further including the step of the service provider giving an opportunity for a current energy provider to adjust its energy costs to the consumer.

24. The method in a computer system according to claim 21 further including initiating an auction between two more energy suppliers to meet the energy requirements of the consumer based upon said optimum contract terms, and awarding a contract for future energy requirements to the low bidder.

25. The method according to claim 21 wherein the service provider functions as a workload dispatcher.
